(19) United States
(12) Patent Application Publication
(10) Pub. No.: US 2010/0086330 A1
(43) Pub. Date: Apr. 8, 2010

(54) Electrophotographic Photosensitive Body, Process for Manufacturing the Same, and Image Forming Apparatus Provided with Such Electrophotographic Photosensitive Body

(75) Inventor: Kouichi Nakano, Hakusan-shi (JP)

Correspondence Address: HOGAN & HARTSON L.L.P., 1999 AVENUE OF THE STARS, SUITE 1400, LOS ANGELES, CA, 90067, US

(73) Assignee: KYOCERA CORPORATION, Kyoto-shi, Kyoto (JP)

(21) Appl. No.: 12/521,279

(22) PCT Filed: Dec. 26, 2007
(86) PCT No.: PCT/JP2007/074989

§ 371 Date: Dec. 7, 2009

(30) Foreign Application Priority Data
Dec. 26, 2006 (JP) 2006-350670

(51) Int. Cl. G03G 15/00; G03G 5/04

(52) U.S. Cl. 399/159; 430/66; 430/132

(57) ABSTRACT

[Problems] To provide an electrophotographic photosensitive body which can perform object identification management more appropriately without having a substantial effect on printing, and to provide its production method and an image forming apparatus equipped with that electrophotographic photosensitive body.

[Means for Solving Problems] The electrophotographic photosensitive body (2) has a cylindrical substrate (20), and a photosensitive layer (211) formed on the outer peripheral surface of the substrate (20). The substrate (20) has an identification code (20b) of the substrate (20) at its inner peripheral section. The process for manufacturing an electrophotographic photosensitive body (2) comprising: a code formation step in which the identification code (20b) is formed in the inner peripheral section of a cylindrical substrate (20); and a photosensitive layer formation step in which a photosensitive layer (211) is formed on the outer peripheral surface of the substrate (20) after the code formation step is implemented thereto. The imaging apparatus is equipped with that electrophotographic photosensitive body (2).

### TECHNICAL FIELD

The present invention relates to an electrophotographic photosensitive body provided with a photosensitive layer formed on an outer peripheral surface of a cylindrical substrate, a process for manufacturing the same, and an image forming apparatus provided with such an electrophotographic photosensitive body.

### BACKGROUND ART

In an image forming apparatus employing an electrophotographic system, an electrophotographic photosensitive body in which deposited layers including a photosensitive layer are formed on an outer peripheral surface of a cylindrical substrate is generally used. In the electrophotographic photosensitive body thus constituted, the respective deposited layers have different film qualities owing to statuses of the substrate and deposition conditions. Therefore, characteristics of the photosensitive layer may be different from one electrophotographic photosensitive body to another, in which case, image characteristics of the image forming apparatus provided with the electrophotographic photosensitive body thus characterized are thereby affected. In order to control such unfavorable impacts on the image characteristics resulting from the different film qualities of the deposited layers, characteristics of the photosensitive layer of each electrophotographic photosensitive body are measured, and conditions for image formation are adjusted based on a result of the measurement.

When the image formation conditions are suitably adjusted, however, it is necessary to inspect the electrophotographic photosensitive bodies respectively, and keep track of an inspection result thereby obtained to be reflected on the image forming apparatus. A technique for managing the inspection result is, for example, to provide an identification code for managing in an outer peripheral section of the cylindrical substrate constituting the electrophotographic photosensitive body. In the case of the photosensitive layer of the electrophotographic photosensitive body containing amorphous silicon as its principal component, however, it becomes difficult to confirm the identification code provided below the photosensitive layer due to light reflections generated by an energy band. In addition to the problem, the technique thus constituted may materially influence the photosensitive layer formed on the outer peripheral surface of the cylindrical substrate.

Under the circumstances, there was developed a technology to bond a label, on which an object identification barcode is printed, to an inner peripheral surface of the electrophotographic photosensitive body provided with the photosensitive layer in order to appropriately control the characteristics of the photosensitive layer. An example of the technology was disclosed in the Patent Document 1.

### Patent Document 1: Japanese Unexamined Patent Publication No. 2005-128365

### DISCLOSURE OF THE INVENTION

### Problem to be Solved by the Invention

However, the technology disclosed in the Patent Document 1, wherein the label is bonded to the inner peripheral surface of the substrate in the electrophotographic photosensitive body by means of an adhesive was disadvantageous in that the label possibly came off because an adhesive component of the adhesive is eluted when the label-attached substrate was placed in, for example, a cleaning solution or in vacuo. More specifically, when the label was bonded to the substrate prior to the formation of the photosensitive layer in the technology according to the Patent Document 1, the adhesive component of the adhesive is eluted, and was then mixed into or attached to the photosensitive layer when the substrate was cleaned in the cleaning solution or placed in vacuo in order to form the photosensitive layer thereon, and printing was possibly thereby affected. As another disadvantage of the technology recited in the Patent Document 1, the eluted adhesive component of the adhesive consequently makes the label come off, and it was not possible to identify and manage the object in some cases.

The present invention was implemented in order to solve the foregoing problems, and aims to provide an electrophotographic photosensitive body which an object can be identified and managed in a more suitable manner without any substantive impacts on printing, a process for manufacturing the same, and an image forming apparatus provided with such an electrophotographic photosensitive body.

### Means for Solving the Problems

According to an aspect of the present invention, an electrophotographic photosensitive body has a substrate and a photosensitive layer. The substrate has a cylindrical shape and is provided with an identification code in an inner peripheral section thereof, and the photosensitive layer is provided on an outer peripheral surface of the substrate.

According to another aspect of the present invention, a process for manufacturing an electrophotographic photosensitive body includes a code formation step and a photosensitive layer formation step. In the code formation step, an identification code is provided in an inner peripheral section of a cylindrical substrate. In the photosensitive layer formation step, a photosensitive layer is formed on an outer peripheral surface of the substrate after the code formation step is implemented thereto.

According to still another aspect of the present invention, an image forming apparatus is provided with the electrophotographic photosensitive body thus constituted.

### EFFECT OF THE INVENTION

According to the present invention, the identification code is provided in the inner peripheral section of the cylindrical substrate in the electrophotographic photosensitive body per se. Therefore, according to the present invention, it is unnecessary to additionally provide a member for identifying an object separately from the substrate in order to identify the electrophotographic photosensitive body in a manner different to the constitution wherein the label is bonded to the inner peripheral surface of the substrate by means of the adhesive or the constitution wherein ink is applied to the inner peripheral surface of the substrate for printing. Accordingly, in the present invention, such a disadvantage that the adhesive component of the adhesive or the components constituting the ink are eluted and then mixed into or attached to the photosensitive layer, which may impact the printing, can be practically prevented from happening. In addition to that, it can be practically avoided in the present invention that the adhesive component of the adhesive leaks out, thereby making the label unglued, and the object identification is made awkward by the melting ink components.

### BEST MODE FOR CARRYING OUT THE INVENTION

As illustrated in FIG. 1, an image forming apparatus 1 according to an embodiment of the present invention includes an electrophotographic photosensitive body 2, an electrification device 3, an exposing device 4, a developing device 5, a transfer device 6, a fixing device 7, a cleaning device 8, and a neutralizing device 9.

The electrophotographic photosensitive body 2, wherein an electrostatic latent image and a toner image based on an image signal are formed, can be rotated in an arrow A direction illustrated in FIG. 1.

The electrification device 3 positively or negatively charges a surface of the electrophotographic photosensitive body 2 depending on a type of a photoconductive layer of the electrophotographic photosensitive body 2. An electrification potential of the electrophotographic photosensitive body 2 is generally at least 200 V and at most 1,000 V.

The exposing device 4 forms the electrostatic latent image on the surface of the electrophotographic photosensitive body 2, and is adapted to emit light having a predetermined wavelength. The exposing device 4 radiates the light on the electrophotographic photosensitive body 2 depending on the image signal and thereby attenuates a potential of a portion where the light is radiated so that the electrostatic latent image is formed on the electrophotographic photosensitive body 2.

The developing device 5 forms the toner image by developing the electrostatic latent image of the electrophotographic photosensitive body 2 using a developer T. The developing device 5 includes a case 50 in which the developer T is housed and a developing sleeve 51.

The developer T constitutes the toner image formed on the surface of the electrophotographic photosensitive body 2, and is electrically charged by friction in the developing device 5. Examples of the developer T are a two-component developer containing, for example, a magnetic carrier and an insulating toner, and a mono-component developer containing a magnetic toner.

The developing sleeve 51 carries the developer T to a developing region between the electrophotographic photosensitive body 2 and the developing sleeve 51.

In the developing device 5 according to the present embodiment, the developer T triboelectrically charged by the developing sleeve 51 is carried in the form of a magnetic brush adjusted to have a predetermined bristle length, and the electrostatic latent image is developed by the carried developer T, so that the toner image is formed. An electrification polarity of the toner image is reverse to that of the electrophotographic photosensitive body 2 in a regular processing, while the electrification polarity has the same polarity as that of the electrophotographic photosensitive body 2 in a reversal processing.

The transfer device 6 serves to transfer the toner image onto a recording paper P fed to a transfer region between the electrophotographic photosensitive body 2 and the transfer device 6, and includes a transfer charger 60 and a separating charger 61. In the transfer device 6, a rear surface of the recording paper P (non-recording surface) is electrically charged to have the polarity reverse to that of the toner image in the transfer charger 60, and the electrification charge and the electrostatic attraction of the toner image transfer the toner image onto the recording paper P. In the transfer device 6, the rear surface of the recording paper P is alternately electrically charged by the separating charger 61 as soon as the toner image is transferred. As a result, the recording paper P is swiftly separated from the surface of the electrophotographic photosensitive body 2.

As the transfer device 6 may use a transfer roller driven by the rotation of the electrophotographic photosensitive body 2 and disposed with a very small distance from the electrophotographic photosensitive body 2 (for example, at most 0.5 mm). The transfer roller is adapted to, for example, apply such a transfer voltage that draws the toner image on the electrophotographic photosensitive body 2 to the recording paper P using a direct-current power supply. When the transfer roller thus constituted is used, the transfer member separating device such as the separating charger 61 is unnecessary.

The fixing device 7 fixes the toner image transferred to the recording paper P, and includes a pair of fixing rollers 70 and 71. In the fixing device 7, the recording paper P passes through between the pair of rollers 70 and 71 to be subject to heat, pressure and the like, so that the toner image is fixed onto the recording paper P.

The cleaning device 8 eliminates the developer T remaining on the surface of the electrophotographic photosensitive body 2, and includes a cleaning blade 80. In the cleaning device 8, the developer T remaining on the surface of the electrophotographic photosensitive body 2 is scraped off and collected by the cleaning blade 80. The developer T collected by the cleaning device 8 may be placed in the case 50 of the developing device 5 to be thereafter recycled.

The neutralizing device 9 eliminates the charges remaining in the electrophotographic photosensitive body 2 and is adapted to emit light having a predetermined wavelength.

A description will be given below in detail of the electrophotographic photosensitive body 2 according to the embodiment of the present invention used in the image forming apparatus 1.

The electrophotographic photosensitive body 2 has a substrate 20 and a deposited layer 21.

The substrate 20 constitutes a principal structural requirement of the electrophotographic photosensitive body 2, and includes a spigot joint portion 20a and an identification code 20b. The object identification is to discriminate a plurality of electrophotographic photosensitive bodies from one another. A shape of the substrate 20 according to the present embodiment is a cylindrical shape, however, is not limited thereto. The shape may be an angular cylindrical or elliptical cylindrical shape.

The spigot joint portion 20a is a portion which is set to have an inner diameter larger than that of a central portion of the substrate 20 in an axial direction. The spigot joint portion 20a can be fitted into a rotation drive mechanism (for example, flange) not shown. When the spigot joint portion 20a of the substrate 20 is fitted into the rotation drive mechanism not shown, a rotation driving force in the arrow A direction is suitably transmitted to the electrophotographic photosensitive body 2.

The identification code 20b is used to identify each substrate 20 (consequently, electrophotographic photosensitive body 2). In the present embodiment, the identification code 20b is formed on an inner peripheral surface 20c of the spigot joint portion 20a.

The identification code 20b according to the present embodiment includes a sensor detector 20ba and a visual identifier 20bb. The sensor detector 20ba is a portion containing a code detectable by an optical sensor. Examples of the optical sensor are a CMOS sensor, a CCD sensor, and a photodiode. Examples of the code detectable by the optical sensor are a one-dimensional code (barcode), a two-dimensional code, and the like. Of these examples, the two-dimensional code having a large amount of information in a unit formation region, in particular, in which a necessary amount of information can be recorded in a relatively small region, is suitably used because the code is not easily affected by the shape of the substrate 20 when it is read, and the code can be accordingly more accurately read. The visual identifier 20bb is a portion containing a code which is visually identifiable. Examples of the visually identifiable code are characters, numerals, and symbols.

The barcode as the sensor detector 20ba (one in the drawing) and strings of characters and numerals (two in the drawing) as the visual identifier 20bb constitute the identification code 20b according to the present embodiment. A plurality of bars constituting the barcode are aligned in the axial direction of the substrate 20. A processing adopted in the formation of the identification code 20b is, for example, a laser processing, cutting, pressing and etching. Of these examples, the laser processing is preferably used in order to reduce a pressing force acting on the substrate 20 and improve a processing performance in a small portion. The laser processing ranges from a processing by YAG laser, a processing by Co₂ laser, to a processing by YV04 laser.

The substrate 20 preferably has an electrical conductivity on its surface. An entire body of the substrate 20 may be made of a conductive material, or a film made of a conductive material may be formed on a surface of a cylindrical body made of an insulating material. Examples of the conducive material constituting the substrate 20 are a metal material, an alloy material including the metal material, and a transparent conducive material. Examples of the metal material are aluminum (Al), stainless steel (SUS), zinc (Zn), copper (Cu), iron (Fe), titanium (Ti), nickel (Ni), chrome (Cr), tantalum (Ta), tin (Sn), gold (Au), and silver (Ag). As the transparent conductive material may be used, for example, ITO (Indium Tin Oxide) and SnO₂. Of these examples of the conductive materials constituting the substrate 20, an Al alloy material is preferably used in view of an adhesive strength with respect to the deposited layer 21 made of a non-monocrystal material (a-Si-based material) in which a silicon atom is used as a matrix, and an Fe alloy material is preferably used in order to increase a mechanical strength, thereby controlling the deformation of the substrate 20. The substrate 20 is preferably made of a metal material or an alloy material including at least one of Al or Fe as its principal component because the possible deformation of the substrate 20 (consequently, identification code 20b) generated by heat applied thereto when a photoconductive layer 211 described later is formed on an outer peripheral surface 20d of the substrate 20 can be sufficiently controlled. As a result, discrimination accuracy in the identification code 20b can be prevented from deteriorating, and the object can be thereby more suitably identified and managed.

The deposited layer 21 includes a photoconductive layer 211 and a surface layer 212, and is formed on the outer peripheral surface 20d of the substrate 20.

The photoconductive layer 211 is a portion where electrons are excited by the light radiated by the exposing device 4 so that a carrier such as a free electron or positive hole is generated. The photoconductive layer 211 according to the present embodiment is laminated and formed directly on the outer peripheral surface 20d of the substrate 20, however, may be laminated and formed on the outer peripheral surface 20d of the substrate 20 with a charge injection preventing layer, a long-wavelength light absorbing layer, or the like, interposed therebetween. Examples of a material constituting the photoconductive layer 211 are an a-Si-based material, a-Se-based materials containing such as a-Se, Se—Te or As₂Se₃, a compound consisting of elements of Group 12 of the periodic table and Group 16 of the periodic table such as ZnO, CdS, CdSe or the like, a material in which particles made of these substances are dispersed in resin, and a photosensitive material such as an OPC-based material. Of these examples of the materials constituting the photoconductive layer 211, the a-Si-based material or an a-Si-based alloy material obtained by adding C, N, O, or the like, to the a-Si-based material is preferably used in view of electrophotographic characteristics (high photosensitivity, high-speed responsiveness, repetitive stability, heat resistance, durability and the like) and consistency relative to the surface layer 212 when the surface layer 212 is made of a-SiC:H. Examples of the a-Si-based material are a-Si, a-SiC, a-SiN, a-SiO, a-SiGe, a-SiCN, a-SiNO, a-SiCO, and a-SiCNO. A film thickness difference of the photoconductive layer 211 in the axial direction of the substrate 20 (arrow BC direction) is preferably set to at most ±3% of a central portion thereof. Thus constituted, the variation of pressure resistance (leakage resistance) and an outer-diameter dimension of the electrophotographic photosensitive body 2 can be significantly lessened. As a result, an image irregularity in the axial direction (arrow BC direction) can be largely controlled.

The surface layer 212 improves the electrophotographic characteristics (charging performance, photosensitivity, potential characteristics, image characteristics, and the like) and durability (wear resistance, printing performance, environmental stability, chemical resistance, and the like) of the electrophotographic photosensitive body 2. The surface layer 212 is laminated and formed on the photoconductive layer 211. As a suitable material used for the surface layer 22 is, for example, any a-Si-based material, and hydrogenated amorphous silicon carbide is particularly preferable in view of hardness and light transmittance.

In the electrophotographic photosensitive body 2 according to the present embodiment, the identification code 20b is present on the inner peripheral surface 20c of the substrate 20 per se. Therefore, in the electrophotographic photosensitive body 2, it is unnecessary to additionally provide a member for identifying an object (label, ink, or the like) separately from the substrate 20 in order to identify the electrophotographic photosensitive body 2 in a manner different to the constitution wherein the label is bonded to the inner peripheral surface 20c of the substrate 20 by means of the adhesive or the constitution wherein ink is applied to the inner peripheral surface 20c of the substrate 20 for printing. Accordingly, such a disadvantage that the adhesive component of the adhesive or the components constituting the ink are eluted and then mixed into or attached to the deposited layer 21, which may impact the printing, can be practically prevented from happening in the electrophotographic photosensitive body 2. In addition to that, it can be practically avoided in the electrophotographic photosensitive body 2 that the adhesive component of the adhesive leaks out, thereby making the label unglued, and the object identification is made awkward by the melting ink components.

Moreover, the identification code 20b of the electrophotographic photosensitive body 2 is provided not on the outer peripheral surface 20d of the substrate 20 but on the inner peripheral surface 20c of the substrate 20. Therefore, in the electrophotographic photosensitive body 2, the distinction of the identification code 20b is substantially free of any influences from the deposited layer 21, and surface states of the outer peripheral surface 20d of the substrate 20 on which the deposited layer 21 is formed is also substantially free of any influences from the deposited layer 21.

As described so far, according to the electrophotographic photosensitive body 2, the object can be identified and managed in a more suitable manner without any substantive influences on the printing.

The identification code 20b in the electrophotographic photosensitive body 2 is formed by the laser processing. Therefore, in the electrophotographic photosensitive body 2, influences generated on the shape of the substrate 20 can be lessened in comparison to such a processing that a relatively large pressing force is applied to the substrate 20, for example, pressing. Accordingly, when the identification code 20b is directly formed on the inner peripheral surface 20c of the substrate 20 in the electrophotographic photosensitive body 2, the printing is thereby less affected. In addition, the laser processing is advantageous in view of its processability because the identification code can be appropriately formed in such a relatively small space as a cylindrical member having an inner diameter of, for example, approximately 60 mm when an optical fiber or the like is utilized therein.

The substrate 20 in the electrophotographic photosensitive body 2 includes the spigot joint portion 20a at the axial end thereof, and the identification code 20b is provided in the spigot joint portion 20a. Therefore, the electrophotographic photosensitive body 2 suitably extends a discriminable range of the identification code 20b which starts at the end portion of the substrate 20 and improves the discrimination of the identification code 20b. Further, in the electrophotographic photosensitive body 2 wherein the identification code 20b is formed in the spigot joint portion 20a of the substrate 20 by the laser processing, the deformation of the substrate 20 is fully controlled in the spigot joint portion 20a having a thickness smaller than that of the axially central portion of the substrate 20.

The electrophotographic photosensitive body 2 including the sensor detector 20ba (barcode) and the visual identifier 20bb (strings of characters and numerals) constitute the identification code 20b. Therefore, a device provided with an optical sensor or visual confirmation can be both adopted for distinction in the electrophotographic photosensitive body 2. Accordingly, in the electrophotographic photosensitive body 2 wherein one of the device with the optical sensor or the visual confirmation is mainly used for the inspection, and the other is used for complementary check, the object can be more reliably identified and managed.

The identification code 20b in the electrophotographic photosensitive body 2 has the sensor detector 20ba including the barcode consisting of the plurality of bars, and the plurality of bars constituting the barcode are aligned in the axial direction of the substrate 20. In this manner, any possible impacts generated on the distinction of the barcode by the curving shape of the cylindrical substrate 20 can be sufficiently reduced in electrophotographic photosensitive body 2, which leads to the improvement of the accuracy in the distinction of the identification code 20b. Thus, the electrophotographic photosensitive body 2 is preferably used to perform the object identification and management in a more suitable manner.

The image forming apparatus 1 according to the present embodiment is provided with the electrophotographic photosensitive body 2. In other words, the image forming apparatus 1 uses the electrophotographic photosensitive body 2 which is more suitably identified and managed. As a result, the image forming apparatus 1, wherein image formation conditions can be more appropriately adjusted, can perform the printing in a more favorable manner.

Next, a process for manufacturing the electrophotographic photosensitive body 2 is described in detail with reference to the accompanying drawings.

First, the substrate 20 including the spigot joint portion 20a, which is illustrated in FIG. 4(a), is prepared.

Next, the identification code 20b indicative of object identification information of the substrate 20 is formed on the substrate 20. More specifically, the desirable identification code 20b is formed on the inner peripheral surface 20c in the spigot joint portion 20a of the substrate 20 by the laser processing in which laser light L is radiated from the end side of the substrate 20. In the laser processing, a light guiding member such as optical fiber may be used to radiate laser light from vicinity of a section to be processed in place of radiating the laser light L from the end side of the substrate 20 using a laser oscillator 22, as illustrated in FIG. 4(b). When the laser processing is thus performed, the laser processing can be appropriately implemented even if, for example, the inner diameter of the substrate 20 is small or the section to be processed is distant from both ends of the substrate 20.

Next, a mirror-like finishing is applied to the outer peripheral surface 20d of the substrate 20 on which the identification code 20b is formed. The mirror-like finishing according to the present embodiment is performed such that the outer peripheral surface 20d of the substrate 20 is cut by a superfine lathe (not shown) having a cutting tool 23 as illustrated in FIG. 4(c). More specifically, cutting oil is applied to the surface-to-be-cut of the substrate 20, and the outer peripheral surface 20d of the substrate 20 is cut by moving the cutting tool 23 in an arrow B direction while rotating the substrate 20 in a circumferential direction thereof at the same time.

Next, the mirror-finished substrate 20 is washed in order to remove the cutting oil used in the mirror-like finishing and cutting flakes generated in the cutting process. More specifically, the mirror-finished substrate 20 is dipped in a washing solution, and supersonic wave is applied to the washing solution. Examples of the washing solution are a water-based detergent, an oil-based detergent, an alcohol-based detergent, and a chlorine-based detergent.

Then, the deposited layer 21 is formed on the outer peripheral surface 20d of the washed substrate 20. More specifically, the photoconductive layer 211 and the surface layer 212 are sequentially laminated on the outer peripheral surface 20d of the substrate 20 according to well-known plasma CVD.

As a result of the operation described so far, the electrophotographic photosensitive body 2 illustrated in FIG. 2 is formed.

In the process for manufacturing the electrophotographic photosensitive body 2 according to the present embodiment, the identification code 20b is formed on the inner peripheral surface 20c of the substrate 20 per se. Therefore, the electrophotographic photosensitive body 2 manufactured by the process according to the present embodiment exerts effects similar to those of the electrophotographic photosensitive body 2 according to the present embodiment described earlier.

In the process for manufacturing the electrophotographic photosensitive body 2 according to the present embodiment, the mirror-like finishing is applied to the outer peripheral surface 20d of the substrate 20 on which the identification code 20b is formed. Therefore, according to the present manufacturing process, when the deposited layer 21 is formed on the outer peripheral surface 20d of the substrate 20, any influences from the deformation of the substrate 20 when the identification code 20b is formed can be more effectively controlled. As a result, in the electrophotographic photosensitive body 2 manufactured by the process according to the present embodiment, the printing is less affected by the formation of the identification code 20b on the inner peripheral surface 20c of the substrate 20 per se.

So far was described the specific embodiment of the present invention. However, the present invention is not limited thereto, and can be variously modified within the scope of the technical idea of the invention.

The identification code 20b in the electrophotographic photosensitive body 2 is formed in the spigot joint portion 20a on the inner peripheral surface 20c of the substrate 20, however, the present invention is not limited thereto. The identification code 20b may be formed in any section other than the spigot joint portion 20a on the inner peripheral surface 20c of the substrate 20 (for example, central portion in the axial direction). Further, a surface processing may be implemented (for example, cutting process or polishing process) to the section where the identification code 20b is formed prior to the formation. In the case where the surface processing is thus applied to the section where the identification code 20b is formed prior to the formation, a discrimination error possibly generated by the surface shape when the sensor detector 20ba and a periphery thereof are distinguished from each other by, for example, an optical sensor, can be prevented.

The electrophotographic photosensitive body 2 including the sensor detector 20ba and the visual detector 20bb constitute the identification code 20b, in, however, the present invention is not limited thereto. Only one of the sensor detector 20ba and the visual detector 20bb may constitute the identification code 20b.

The outer peripheral surface 20d of the substrate 20 in the electrophotographic photosensitive body 2 preferably has an arithmetic mean height Ra (measured in compliance with the JIS standards B0601: 2001) of at most 0.05 μm. Thus constituted, when the deposited layer 21 is formed, it is prevented from overly growing. As a result, flatness can be suitably increased.

In the substrate 20 of the electrophotographic photosensitive body 2, at least one of materials selected from a group consisting of chrome oxide, iron oxide and manganese oxide may be provided in the region of the inner peripheral surface 20c where the identification code 20b is present. Thus constituted, the region where the identification code 20b is formed can be presented in a color different to that of any other section (for example, black). As a result, the identification code can be more suitably identified.

In the process for manufacturing the electrophotographic photosensitive body 2 according to the present embodiment, the mirror-like finishing is applied to the outer peripheral surface 20d of the substrate 20 after the identification code 20b is formed, however, the present invention is not limited thereto. The identification code 20b may be formed on the substrate 20 in which the outer peripheral surface 20d is already mirror-finished.

### BRIEF DESCRIPTION OF THE DRAWINGS

FIG. 1 is a view illustrating a schematic constitution of an image forming apparatus according to an embodiment of the present invention.

FIG. 2A is a perspective view of a schematic constitution of an electrophotographic photosensitive body according to the embodiment of the present invention.

FIG. 2B is a sectional view taken along line IIb-IIb of FIG. 2A.

FIG. 3A is a perspective view of a schematic constitution of a substrate constituting the electrophotographic photosensitive body illustrated in FIG. 2A.

FIG. 3B is a sectional view taken along line IIIb-IIIb of FIG. 3A.

FIG. 4A is an illustration of a process for manufacturing the electrophotographic photosensitive body illustrated in FIG. 2A.

FIG. 4B is an illustration of a process continued from the process illustrated in FIG. 4A.

FIG. 4C is an illustration of a process continued from the process illustrated in FIG. 4B.

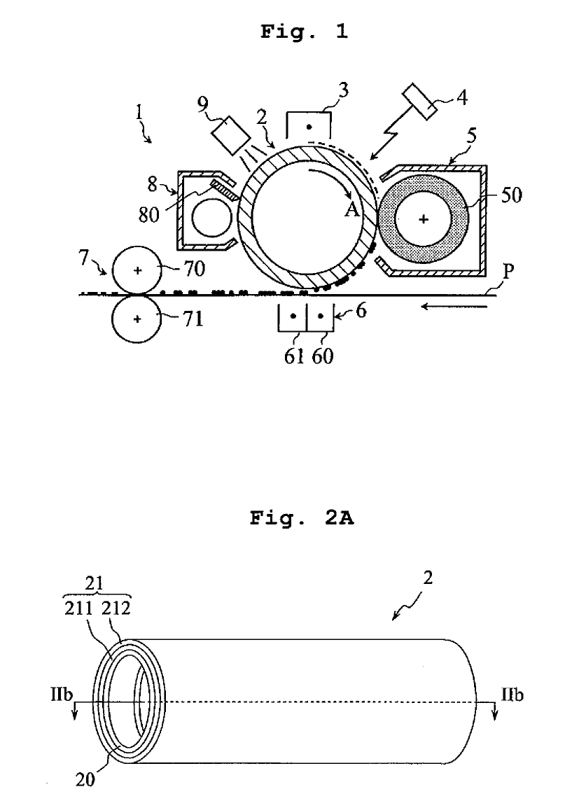

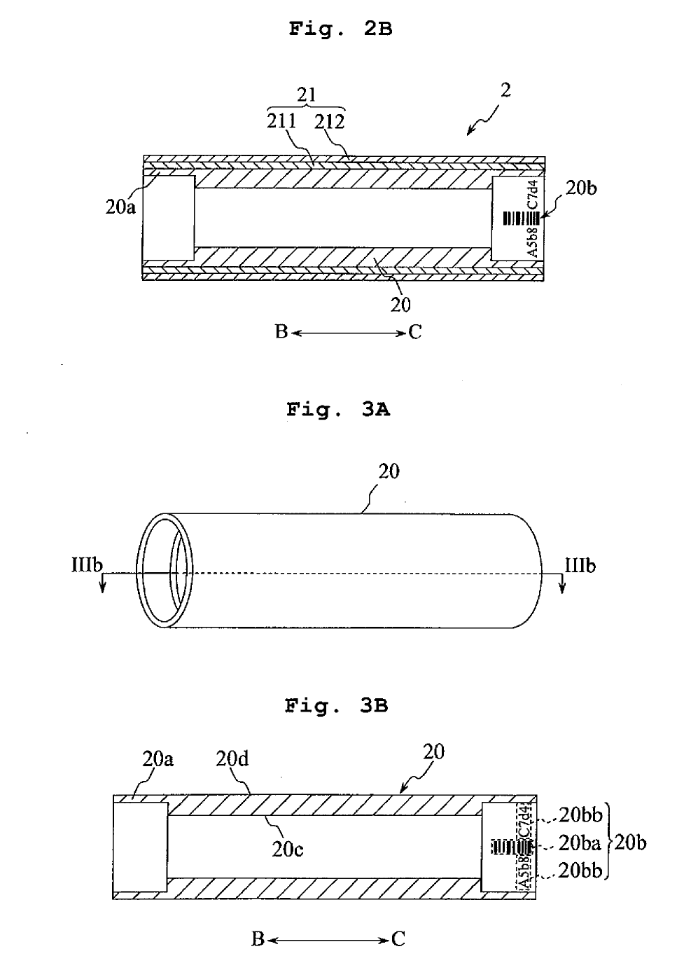

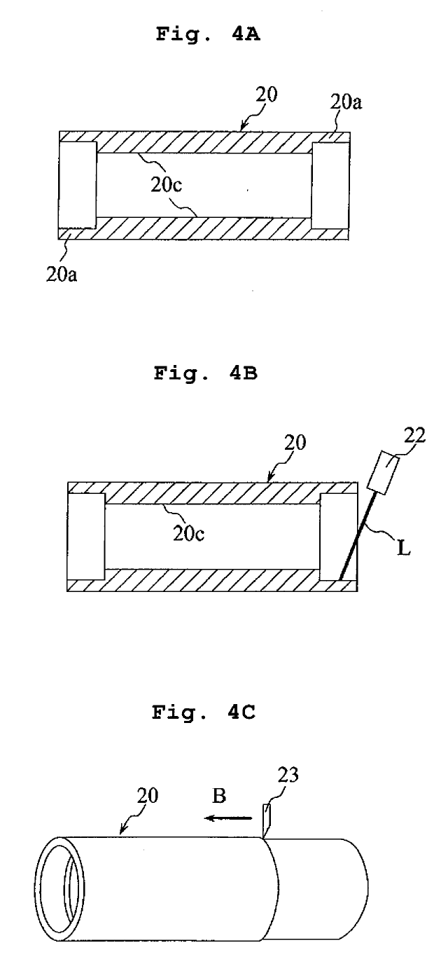

### DESCRIPTION OF REFERENCE SYMBOLS

1 Image forming apparatus
2 Electrophotographic photosensitive body
20 Substrate
21 Deposited layer
211 Photoconductive layer (photosensitive layer)
212 Surface layer
22 Laser oscillator
23 Cutting tool
3 Electrification device
4 Exposing device
5 Developing device
5 Developing sleeve
6 Transfer device
60 Transfer charger
61 Separating charger
7 Fixing device
70, 71 Roller
8 Cleaning device
80 Cleaning blade
9 Neutralizing device
P Recording paper

1. An electrophotographic photosensitive body comprising:
a substrate having a cylindrical shape and provided with an identification code in an inner peripheral section thereof; and
a photosensitive layer provided over an outer peripheral surface of the substrate.

2. The electrophotographic photosensitive body according to claim 1, wherein
the identification code is formed by a laser processing.

3. The electrophotographic photosensitive body according to claim 1, wherein
the substrate includes a spigot joint portion at an end portion thereof in an axial direction.

4. The electrophotographic photosensitive body according to claim 3, wherein
the identification code is provided in the spigot joint portion.

5. The electrophotographic photosensitive body according to claim 1, wherein
the identification code includes a sensor detector detected by an optical sensor and a visual identifier visually identified.

6. The electrophotographic photosensitive body according to claim 1, wherein
the identification code includes a sensor detector including a barcode.

7. The electrophotographic photosensitive body according to claim 6, wherein
a plurality of bars constituting the barcode are aligned in an axial direction of the substrate.

8. The electrophotographic photosensitive body according to claim 1, wherein
the substrate comprises metal or alloy including at least one of aluminum and iron as a principal component thereof.

9. The electrophotographic photosensitive body according to claim 1, wherein
at least an oxide selected from a group consisting of chrome oxide, iron oxide and manganese oxide is provided in a region on the inner peripheral surface of the substrate where the identification code is present.

10. A process for manufacturing an electrophotographic photosensitive body comprising:
a code providing step of forming an identification code in an inner peripheral section of a cylindrical substrate; and
a photosensitive layer providing step of forming a photosensitive layer over an outer peripheral surface of the substrate after the code providing step is implemented.

11. The process for manufacturing an electrophotographic photosensitive body as claimed in claim 10, further comprising a mirror-like finishing step of polishing outer peripheral surface of the substrate to a mirror-like surface after the code providing step is mirror-finished.

12. An image forming apparatus comprising the electrophotographic photosensitive body claimed in claim 1.
